(19) United States
(12) Patent Application Publication
(10) Pub. No.: US 2019/0232522 A1
(43) Pub. Date: Aug. 1, 2019

(54) IN-PLANE ISOTROPIC, BINDERLESS PRODUCTS OF CELLULOSIC FILAMENT BASED COMPOSITIONS BY COMPRESSION MOLDING

(71) Applicant: FPInnovations, Pointe-Claire (CA)

(72) Inventors: Natalie PAGE, Laval (CA); Michelle Agnes RICARD, Pointe-des-Cascades (CA); Marc-Antoine BRUNET, Dorval (CA); Halim CHTOUROU, Kirkland (CA); Cloé BOUCHARD-AUBIN, Laval (CA)

(21) Appl. No.: 16/333,676

(22) PCT Filed: Sep. 19, 2017
(86) PCT No.: PCT/CA2017/051101

§ 371 Date: Mar. 15, 2019

Related U.S. Application Data
(60) Provisional application No. 62/396,402, filed on Sep. 19, 2016.

(51) Int. Cl. B27N 3/04; B27N 3/10

(52) U.S. Cl. CPC B27N 3/04; B27N 3/10

(57) ABSTRACT

The present description relates to in-plane isotropic products derived from cellulosic filament based compositions that are substantially free of binders; and comprising inorganic fillers with an average particle size of less than 5 μm; and methods for producing these in-plane isotropic products. The method comprising providing a cellulosic filament substantially free of any binder; providing an inorganic filler comprising an average particle size of less than 5 μm; mixing the cellulosic filament and the filler to produce a slurry; transferring the slurry in a preforming jig to produce a wet mat in the jig; and hot press compression molding the mat to produce the in-plane isotropic product. The inorganic fillers were uniquely shown substantially useful to accelerate the final dewatering (drying) in the hot press at 150° C./250 psi and to eliminate delamination issue insitu the molded products. Furthermore, the hot press molded products were remarkably improved with respect to the surface quality and the dimensional stability with outstanding increase in its tensile, flexural and impact properties, all with respect to the cellulosic filament inorganic filler-free molded products.

### BACKGROUND

### i) Field

The present specification relates to in-plane isotropic products derived from cellulosic filament based compositions that are binderless (i.e. substantially free of binders); and methods for producing these products by compression molding.

### ii) Description of the Prior Art

As described by Hua et al (US20110277947A1; US20130017394A1), when wood pulp fibers are suitably refined, to peel the fibers into cellulose filaments, the resulting filaments have no lumen and are considerably thinner than the parent fibers while maintaining much of their length. The unique morphology of these cellulose filaments increase their flexibility and promote their entanglement. Furthermore, these filaments have a higher surface area when compared to the parent fiber which exposes more hydroxyl groups per given weight. Higher amounts of surface hydroxyl groups in turn lead to increased hydrogen bonding density. When an aqueous suspension of these cellulose filaments was used in compression molding process under high temperature, the dewatering and drying times were in the order of several hours. Furthermore, the resulting products were non uniform and dimensionally unstable.

Production of fibrillated cellulose pulp, microfibrillated cellulose and nanofibrillated cellulose are made by applying either mechanical or chemical energy to conventional pulp which in turn liberates fibrils of cellulose that are much narrower than original pulp fibers, providing access to much more hydrogen bond sites than in the original material. Advantageous use of these hydrogen bonds to produce solid products without pressing has been reported (U.S. Pat. No. 6,379,594B1 and WO2011/138604 A1).

As early as 1997, DOpfner et al (CA 2,237,942) described the forming and molding of work pieces from aqueous cellulose microfiber pulp without the addition of bonding or filler material or use of external pressure. The cellulosic material was produced from hemp or other sources of cellulose. The manufacture of this microfiber material and the formation of binderless work pieces in stamping molds, but without pressure, were also described by DOpfner et al in a second patent (U.S. Pat. No. 6,379,594 B1).

In 2011, Dean and Hurding (WO2011/138604 A1, US20130101763) patented various products using fiber and fiber pulps where the microfiber acted as a self-bonding agent or microfibrous matrix capable of holding conventional fiber pulps, plastics, or fillers. US20130101763 A1 refers to the fabrication of microfiber pulp, and that other fibrillated cellulose fibers such as macro-, micro-, and nanofiber pulp can also be used. The self-binding nature of the microfiber was thought to mean that compatibilizers and polymeric matrices, typically required for composites, were not required in the fabrication of the cellulosic binderless pieces.

The end products made by Dean and Hurding were described according to their final density as either high or medium density products. Products were composed of 1-80% micro fiber with addition of 1-20% of conventional cellulosic fibers that were made from wood, grasses, straws or reeds. The range of end products made from these fiber self-binding systems included finishing boards or panels used for structural or finishing purposes in the construction industry. High density products of 1-1.5 g/cm³ and medium density products of 0.5-0.9 g/cm³ could be made with panel thicknesses varying from 1 to 25 mm. Dean and Hurding (US20130101763 A1) claimed that the addition of up to 35% of inorganic fillers such as calcium carbonate, talc or clay could increase the final product density to greater than 1.5 g/cm³. The products could be colored or brightened with the addition of mineral or synthetic colors, aluminum sulfate mordant or optical brighteners. The fabrication of larger 3D heating briquettes was described that had low flare with high calorific values. Metal salts to color the resulting flame emitted from briquettes could also be added. In other cases, the fiber binderless system, acting as matrix as stated by Dean and Hurding (US20130101763 A1), could hold from 1-49% of oil or bio-based plastic particles such as polypropylene.

Although Dean and Hurding (WO2011/138604 A1) describe the types and proportions of pulp fiber used, the shaping of a work piece, and the removal of water with the use of external pressure prior to drying, no detailed methods of work piece molding process were described. Furthermore, the combination of microfibers and conventional cellulosic fibers was always cited in the embodiments of Dean and Hurding (WO2011/138604 A1), most probably to accelerate the dewatering before and during the final drying. The microfiber content in the end work piece products never exceeded 80% by weight, as detailed by Dean and Hurding (WO2011/138604 A1).

Lee and Hunt (US20130199743A1) describe wet forming and compression molding processes to make binderless cellulosic fiber based panels and boards by using relatively low quality fibers, wood particles, such as saw dust and other natural wood components like lignin. Dewatering through vacuum and compression molding was accelerated through the addition of wood particles of larger dimensions than the pulp fibers.

### SUMMARY

In accordance with one aspect, there is provided a method of hot press compression molding an in-plane isotropic product comprising providing a cellulosic filament substantially free of a binder; providing an inorganic filler comprising an average particle size of less than or equal to 5 μm; mixing the cellulosic filament and the filler to produce a suspension; transferring the suspension to a preforming jig to produce a mat in the jig; and compression molding the mat to produce the in-plane isotropic product.

In accordance with another aspect, there is provided the method herein described, wherein the mat is further pressed to produce a preform and the preform is compression molded to produce the in-plane isotropic product.

In accordance with another aspect, there is provided the method herein described, wherein the suspension is 5 to 10 wt % solids.

In accordance with another aspect, there is provided the method herein described, wherein the preform is a consistency of 30 to 55 wt % solids.

In accordance with another aspect, there is provided the method herein described, wherein the inorganic filler for example are selected from the group consisting of CaCO₃, Mg(OH)₂, Al(OH)₃, Al₂O₃, B₂O₆Zn₃ or combinations thereof.

In accordance with another aspect, there is provided the method herein described, wherein the average particle size of the filler is less than 3 μm.

In accordance with another aspect, there is provided the method herein described, wherein the average particle size of the filler is between 1 and 3 μm.

In accordance with another aspect, there is provided the method herein described, wherein the compression molding is at ambient temperature and 250 psi to prepare a preform.

In accordance with another aspect, there is provided the method herein described, wherein the compression molding is done at an incremental increases in temperature of up to 150° C. and incremental increases in pressure of up to 1000 psi.

In accordance with another aspect, there is provided the method herein described, wherein the filler is 10 to 20% of the weight of the cellulose filament.

In accordance with another aspect, there is provided an in-plane isotropic product comprising a cellulosic filament substantially free of a binder; a filler comprising an average particle size of less than or equal to 5 μm.

In accordance with another aspect, there is provided the product herein described, wherein the filler is like CaCO₃, Mg(OH)₂, Al(OH)₃, Al₂O₃, B₂O₆Zn₃ or combinations thereof.

In accordance with another aspect, there is provided the product herein described, wherein the average particle size of the inorganic filler is less than 3 μm.

In accordance with another aspect, there is provided the product herein described, wherein the average particle size of the inorganic filler is between 1 and 3 μm.

In accordance with another aspect, there is provided the product herein described, wherein the product comprising 20% by weight of inorganic filler has a density in the range of 1.25 to 1.56 g/cm³.

In accordance with another aspect, there is provided the product herein described, wherein the product comprising 20% by weight of filler has a tensile strength superior to that of the non-filled product and greater than 50 MPa.

In accordance with another aspect, there is provided the product herein described, wherein the product comprising 20% by weight of filler has a flexural strength superior to that of the non-filled product and greater than 80 MPa.

In accordance with another aspect, there is provided the product herein described, wherein the product comprising 20% by weight of filler has an impact strength superior to that of the non-filled product and greater than 8 kJ/m².

The cellulose filament based compounds described herein relate to and are suitable for accelerated dewatering compression molding, in a preferred embodiment by hot press compression molding. Final products are in-plane isotropic and binderless with enhanced surface uniformity, dimensional stability and mechanical properties. Also described herein are methods of compression molding of aqueous suspension of pure cellulose filaments or cellulose filament based compositions to produce in-plane isotropic binderless products with two dimensions such as flat panels or simple three dimensions such as fluted panels.

The method described herein for producing binderless and in-plane isotropic products from pure cellulose filaments or cellulose fibrils homogenously dispersed with inorganic fillers in a water suspensions, includes a first step of uniformly preforming the suspensions and then compression molded under high temperature to dryness. A variety of geometries, sizes, and surface finishes can be made. The present description further illustrates the parameters and mold design required for the compression molding of dimensionally stable products.

The method to accelerate dewatering and drying of the cellulose filament or fibril suspensions and products described herein relates to the addition of inorganic fillers to the suspension prior to the preforming stage. Added functionalities may also be given to the final product depending on the choice of inorganic fillers used. In other embodiments, addition of lower density fillers such as inorganic hollow microspheres might be selected for lowering the final binderless product density. Furthermore, expandable polymeric beads can also be added for further lightweight binderless products.

The products described herein are unique in terms of: 1) the used cellulosic material compositions are pure cellulose filaments, produced as described by Hua et al (US20130017394A1), without any addition of conventional cellulosic fibers or wood particles; 2) a high temperature compression molding process is described to accelerate dewatering and consolidation of cellulose filaments; and 3) the addition of inorganic fillers to accelerate the dewatering rate.

Prior to the method described herein, there was no hot press compression molding method for the production of cellulose filament-based products reported. Methods for making such products are described herein.

### BRIEF DESCRIPTION OF THE DRAWINGS

FIG. 1a is a bar chart of water absorption (weight %) of one embodiment of the present binderless air dried cellulose filament (CF) material compared with: maple wood, medium density fiber board (MDF), particle board (PB) panels, and high density polyethylene (HDPE) plastic;

FIG. 1b are photographs of the binderless air dried cellulose filament (CF) material, the maple wood; medium density fiber board (MDF); particle board (PB) panels, and high density polyethylene (HDPE) plastic tested after a vertical burning test, where the CF samples show good fire resistance and little charring, as compared to the other materials tested;

FIG. 1c is a bar chart of hardness (N) of one embodiment of the present binderless air dried cellulose filament (CF) material compared with: maple wood, medium density fiber board (MDF), particle board (PB) panels, and high density polyethylene (HDPE) plastic;

FIG. 1d is a bar chart of Impact Value (ft*lbs) of one embodiment of the present binderless air dried cellulose filament (CF material compared with: maple wood, medium density fiber board (MDF), particle board (PB) panels, and high density polyethylene (HDPE) plastic;

FIG. 2a Scanning electron micrograph of one embodiment of an air dried binderless product described herein;

FIG. 2b Scanning electron micrograph of one embodiment of a milled air dried binderless product described herein;

FIG. 2c Scanning electron micrograph of one embodiment of a compression molded binderless product described herein, where the product is produced at a pressure of 247 psi from an initial water suspension consistency of 10% by dry weight;

FIG. 3. Illustrates various process options of flow diagrams to arrive at various embodiments of binderless cellulose filament based products described herein, in one embodiment a suspension of CF water and additives is transferred to a preforming jig and then either made into a preform before hot compression molding or directly hot compression molded or air dried.

FIG. 4a is a photograph of a side view of a non-buffed sample of one embodiment of a binderless cellulose filament panel, produced from a water suspension consistency of 20 weight % water/solids;

FIG. 4b is a photograph of a front view of a buffed sample of one embodiment of a binderless cellulose filament panel, produced from a water suspension consistency of 20 weight % water/solids;

FIG. 4c is a photograph of a side view of a non-buffed sample of one embodiment of a binderless cellulose filament panel, produced from a water suspension consistency of 30 weight % water/solids;

FIG. 4d is a photograph of a front view of a buffed sample of one embodiment of a binderless cellulose filament panel, produced from a water suspension consistency of 30 weight % water/solids;

FIG. 5 is a bar chart of tensile strength (MPa) of various embodiments (100% CF-120 min., 20 wt % CaCO₃ 25 μm-25 min., 20 wt % CaCO₃ 2.8 μm-45 min., and 20 wt % CaCO₃ 2.8 μm-90 min.) of binderless cellulose filament based panels described herein molded by hot press compression for the indicated time interval;

FIG. 6a is a bar chart of density (g/cm³) of compression molded 100% CF, with 20 wt % CaCO₃ 2.8 μm. and 25 wt % Mg(OH)₂ 1.8 μm embodiments of cellulose filament based panels described herein;

FIG. 6b is a bar chart of tensile strength (MPa) of compression molded 100% CF with 20 wt % CaCO₃ 2.8 μm. and 25 wt % Mg(OH)₂ 1.8 μm embodiments of cellulose filament based panels described herein;

FIG. 6c is a bar chart of flexural strength (MPa) of compression molded 100% CF with 20 wt % CaCO₃ 2.8 μm. and 25 wt % Mg(OH)₂ 1.8 μm embodiments of cellulose filament based panels described herein;

FIG. 6d is a bar chart of compression strength (MPa) of compression molded 100% CF with 20 wt % CaCO₃ 2.8 μm. and 25 wt % Mg(OH)₂ 1.8 μm embodiments of cellulose filament based panels described herein;

FIG. 6e is a bar chart of impact strength (kJ/m²) of compression molded 100% CF with 20 wt % CaCO₃ 2.8 μm. and 25 wt % Mg(OH)₂ 1.8 μm embodiments of cellulose filament based panels described herein;

FIG. 6f is a bar chart of water absorption after 24 hours (wt %) of compression molded 100% CF with 20 wt % CaCO₃ 2.8 μm. and 25 wt % Mg(OH)₂ 1.8 μm embodiments of cellulose filament based panels described herein;

FIG. 7a is a schematic diagram of a bottom view; cross-sectional view, and side view under vacuum—of a vacuum assisted jig used to dewater cellulose filaments suspension into a flat preform according to one embodiment described herein at ambient temperature compression and 250 psi, wherein preform consistency varies from ˜30% to 55% by weight solids;

FIG. 7b is a schematic diagram of a top view; cross-sectional view, and side view—of a 4 to 6 face dewatering jig used to dewater cellulose filaments suspension into a flat preform according to one embodiment described herein at ambient temperature compression at 250 psi, wherein preform consistency varies from ˜30% to 55% by weight solids;

FIG. 8 is a bar chart that illustrates the effect that various compression molding cycles have on the tensile strength (MPa) have on a binderless cellulose filament containing 20% calcium carbonate (CaCO₃) of 2.8 μm according to embodiment described herein as shown in Table 1;

FIG. 9a is a photograph of binderless cellulose filament based corrugated panels made by compression molding according to one embodiment described herein;

FIG. 9b is a photograph of a binderless cellulose filament based assembled corrugated sandwich panel made by compression molding according to one embodiment described herein;

FIG. 9c is a photograph of a binderless cellulose filament based assembled honeycomb sandwich panel made by compression molding according to one embodiment described herein;

FIG. 10a is a photograph of a surface finish of cellulose filament based product according to one embodiment described herein;

FIG. 10b is a photograph of an embossed surface finish of cellulose filament based product according to one embodiment described herein;

FIG. 10c is a scanning electron micrograph of a surface finish of a fine wire cellulose filament based product according to one embodiment described herein;

FIG. 11 is a bar chart that illustrates in-plane isotropic tensile strength (MPa) of compression molded products of cellulose filaments described herein.

### DETAILED DESCRIPTION

### Definitions

The cellulose filaments used and described herein are those of Hua et al (US20130017394A1); having the following properties; their thin width of approximately 30 to 100 nm and low thickness of approximately 50 nm and their high length of up to millimeters. These characteristics increase their flexibility, specific surface area, promote entanglements, and enhance hydrogen bonding density.

Binderless is defined herein as substantially free of any binders that would be understood to bind the cellulose filaments described herein together. Binders are understood to include but are not limited to any bio-based such as starch and latex; and oil based polymeric matrix known as thermoplastic such as polypropylene, nylon, and poly-lactic acid (PLA) or thermoset resins such as polyester, vinyl ester, epoxy, polyurethane; formaldehyde based binders such as urea formaldehyde, polymeric diphenyl methane diisocyanate (pMDI); or synthetic fibres such as polyester, polypropylene and nylon and polypropylene; or adhesives such as polyvinyl acetate and polyvinyl alcohol.

In-plane isotropic is defined herein as having identical properties in all in-plane directions/or axes. The cellulose filaments are randomly oriented in compression molded products; this being distinct from natural wood and engineered wood products (i.e. plywoods, cross-laminated timber) and have varying properties in different in-plane directions/axes.

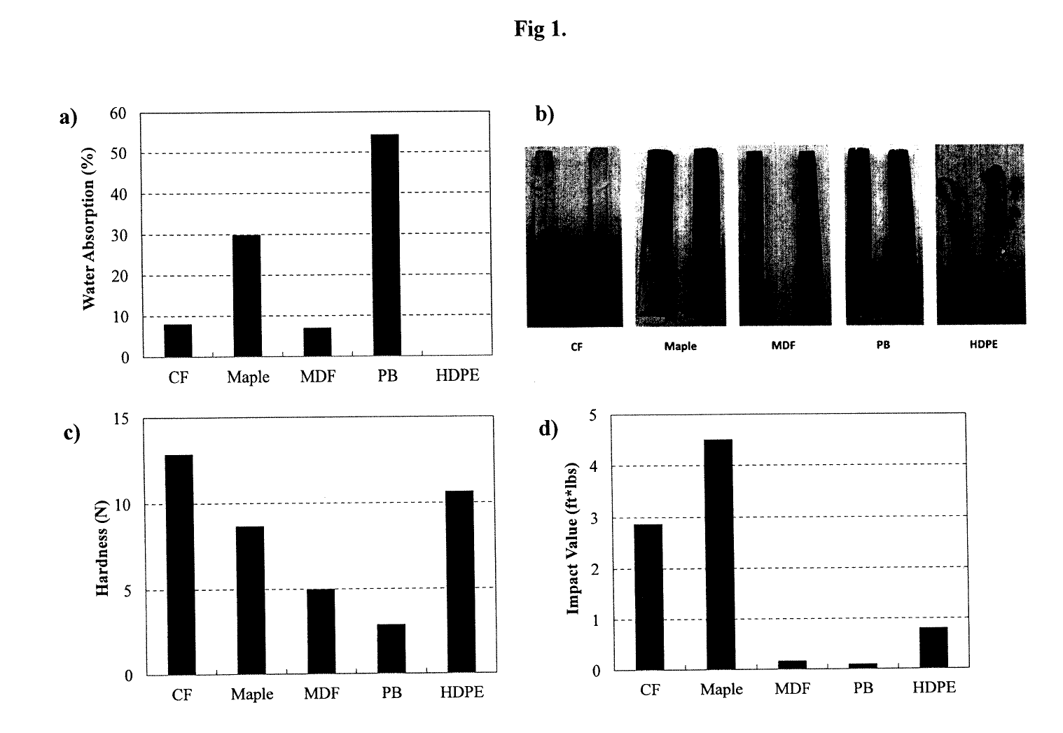

As in prior art references (US 2013/0199743 A1 and US 2013/0017394 A1), the ability of cellulose filaments to form an isotropic solid block material by a simple ambient air drying over a period of weeks of an aqueous suspension has been noticed by the refiner operators and demonstrated in the laboratory. The air dried isotropic solid was found to have impressive properties, namely its specific gravity of 1.5 g/cm³, equal to that of pure cellulose, its hardness, and its distinguish fire resistance with respect to other cellulosic materials. FIG. 1 shows some properties of an air-dried cellulose filament material which are compared to maple, medium density fiberboard (MDF), particleboard (PB) and high density polyethylene (HDPE). FIG. 1a shows a very low level of water absorption of less than 10% after a 24 h immersion in ambient water. FIG. 1b shows that air dried 100% cellulose filament samples exhibit a good fire resistance and no blackening, when exposed to flame in a vertical burning test. FIGS. 1c and 1d illustrate the hardness and impact resistance of the air dried cellulose filament samples, which are comparable or even superior to those of maple wood, engineered wood composites and petroleum-based products currently on the market. Furthermore, material handling showed that these air dried cellulose filament products could be machined, polished, assembled with nails and screws.

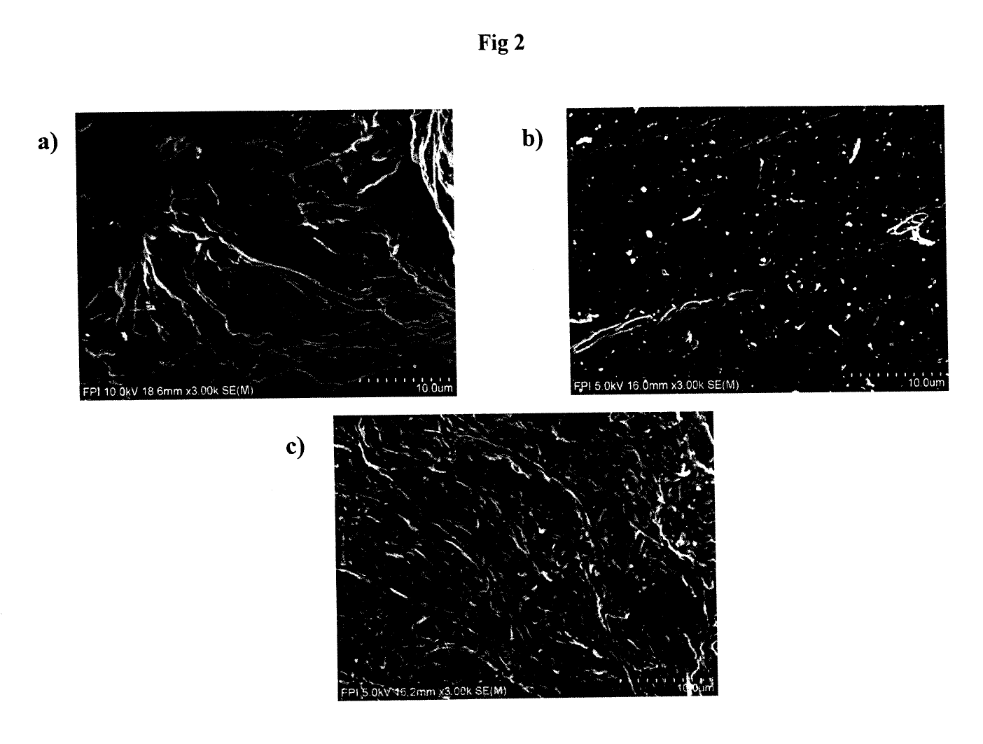

This present description illustrates methods and equipment that produce cellulose filament based products in an industrially viable compression molding process under high temperature. This process accelerates dewatering, drying and consolidation of the cellulose filament products, is flexible in that it allows application of different temperature and pressure cycles. By changing the temperature and pressure cycles, compression molding process gives the manufacturer added ways to control the mechanical properties, dimensional stability, and surface quality of the molded products. FIG. 2 shows a scanning electron micrograph of an air dried product in comparison with a compression molded cellulose filament panel. The micrograph in FIG. 2a shows the consolidation of cellulose filaments at the surface of an air dried product. FIG. 2b shows the surface of an air dried product after the mechanical action induced by the milling machine to cut the samples. At this point the individual cellulose filaments are undistinguishable illustrating a high level of self-consolidation or self-bonding. This high consolidation may prevent water absorption or flame propagation into the air dried products. This consolidated phase has an appearance similar to what is seen in a single continuous phase matrix of typical thermoplastics. In addition, the sound of the panel hitting against a table edge has a sound similar to a composite object rather than a piece of wood. Unlike the air dried product, the micrographs of FIG. 2c of the compression molded panel shows random orientation of individually distinguishable cellulose filaments and the presence of pores of 1-5 μm in size dispersed within the structure.

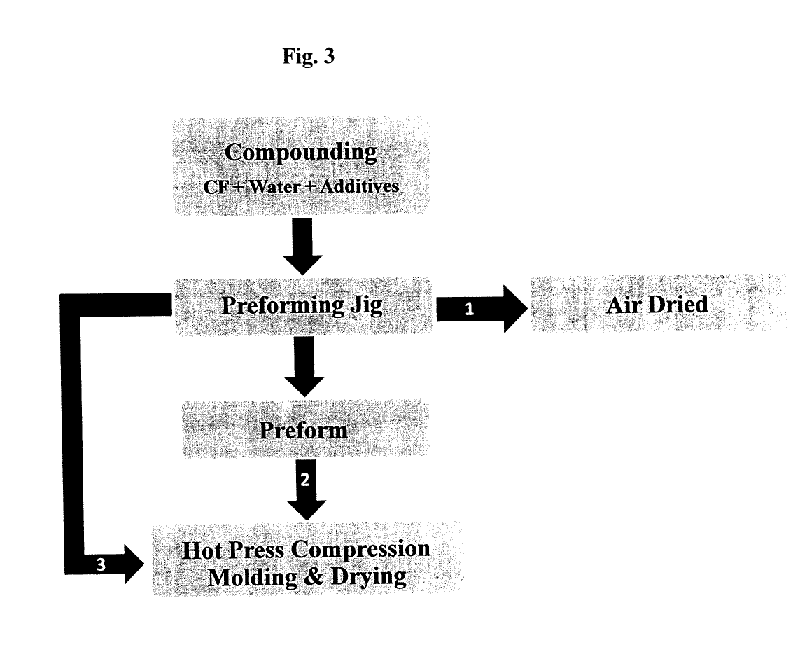

The flow chart in FIG. 3 illustrates three methods to prepare solid products from aqueous compounds of cellulose filament with inorganic fillers: 1) ambient air drying of the preformed product inside a jig; 2) hot press compression molding of the preform outside a jig; and 3) hot press compression molding of the preform in the jig. All relevant steps of these methods which are mainly the aqueous compounding, the first dewatering through the preforming jig, and then the final drying either by hot press compression molding or by a ambient air drying will be described in more details below.

### Compounding

The formulation embodiments described herein are prepared by compounding aqueous suspensions of cellulose filament and inorganic fillers. This aqueous compounding is a very critical step required to convey uniformity and in-plane isotropic properties to the final products.

The embodiments described herein are prepared using pure cellulose filament pulp which was manufactured in pilot scale at 30% consistency as described by Hua et al (US20130017394A1). A medium to high consistency laboratory pulper was used to attain uniform aqueous suspensions of cellulose filaments within 10 min at 800 rpm. A 10% consistency based on dry weight was used for aqueous compound cellulose filament with inorganic fillers. The 10% dry consistency was suitable to optimize the dispersion and the entanglement of the cellulose filaments while minimizing the air entrapment within the aqueous suspensions. Low compound consistency and the addition of inorganic fillers both contribute to limiting the defects in the cellulose filament based products as well as improving their uniformity.

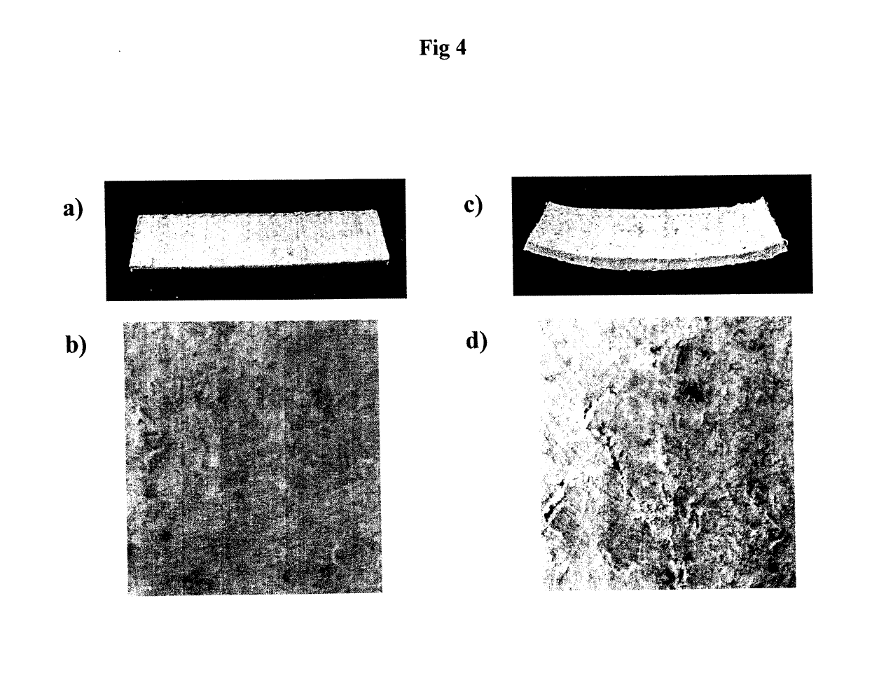

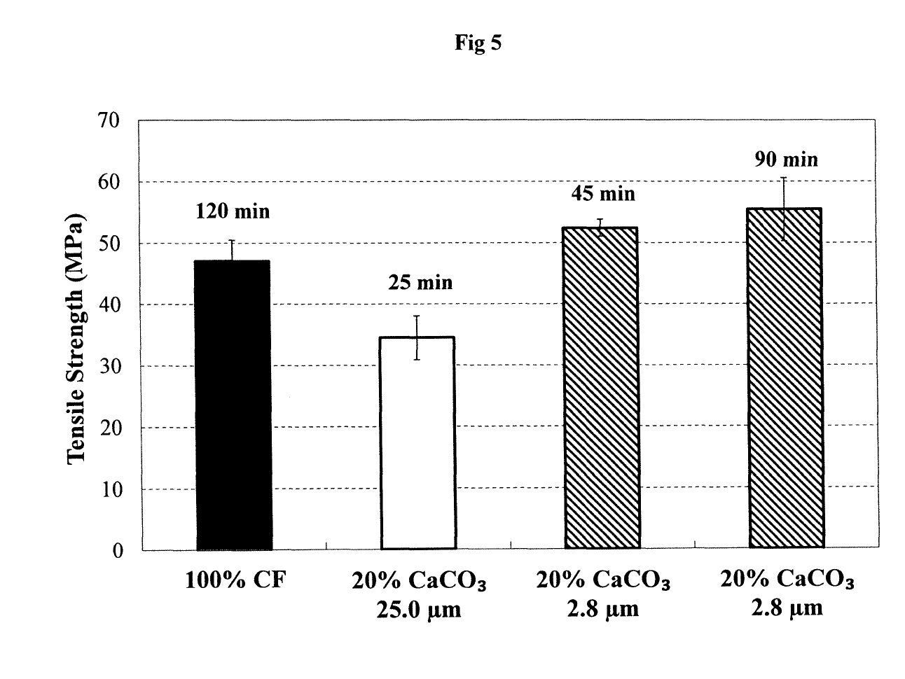

Other means of mixing can be used such as industrial compounders, blenders, mixers or pulpers. It is preferable to keep the compounding consistency at or below 10% for the benefits explained above. In one embodiment the suspension consistency is 5 to 30% solids, where in a preferred embodiment the suspension consistency is 5-15% solids, and in a particularly preferred embodiment the suspension consistency is 5-10 solids. Even though a lower consistency will improve the suspension and product uniformity, excessive dilution should be avoided in order to minimize the time and the dimensions of the tools required for the dewatering phases. More particularly, the level of dilution affects the volume of the compounder and the height of the jig required for dewatering the suspension into the desired preform. Dilution is nevertheless essential to minimize the defects, reduce the standard deviation of the measured physico-mechanical properties and dimensional stability of the final products. FIG. 4 shows lateral views of compression molded panels after room temperature conditioning (4a, c), and top views of the same panels after a buffing treatment (4b, d) for 20% (4a, b) and 30% (4c, d) consistency suspensions. The photographs show that products made from higher consistency during compounding had more defects and greater deformation, curl or warping.

FIGS. 4b and d show that the high pressure and temperature of the compression molding process cannot overcome the resistance to flow of a high consistency compound of cellulose filaments of 20-30%. Clearly, the entanglement and aggregation of the cellulose filament compound, does not allow lateral flow inside the mold that would equilibrate the material density of the final product. Unlike polymeric matrix, cellulose filaments cannot melt and flow when subjected to heat and pressure. In addition at high compound consistency, the transfer of the compound into the preforming jig is more critical leading to non-uniformities in the preform and/or final product.

Inorganic fillers are widely used in different industries such as paper making, coating, polymer reinforced composites, etc. In prior paper making art, Laleg et al (WO/2012/040830) and Dorris et al (US20160102018) have shown that cellulose filaments have the ability of retaining up to 92% by weight of inorganic fillers within their network to form highly filled papers and boards.

Inorganic fillers are typically used in composites to lower cost, increase stiffness and sometimes to increase fire resistance (aluminum tri-hydroxide). Also disclosed herein is a novel use for the inorganic fillers in compression molding. In compression molding of cellulose filaments, a defined amount of inorganic fillers are added during the compounding of aqueous suspension to accelerate drying and to improve the uniformity of the final product. Furthermore, the addition of inorganic fillers uniquely improves the dimensional stability and the surface quality of the compression molded products.

FIG. 5 shows the impact of filler addition and mean particle size on the drying times and tensile strength of compression molded panels of cellulose filaments of 3 mm in thickness dried to 99% consistency at a maximum temperature of 150° C. and 247 psi. Addition of 20% calcium carbonate filler with mean particle size of 25 μm reduced the drying time of the panels by 79% going from 120 min to 25 min, but decreased the strength by 27%. If this 25 μm mean particle size calcium carbonate filler is replaced with a smaller mean particle size filler of 2 to 3 μm, then the panels retain their original tensile and flexural strengths and may obtain even higher strength. In such embodiments, the reduction in drying time is lesser, in the order of 62% going from 120 min to 25 min, when compared to the 100% cellulose filament panel. Dimensional stability of inorganic filler-containing panels was improved as well as their brightness and surface properties. Brightness of the panels increased from 24% for pure cellulose filament panels to 62% with the addition of 20% of calcium carbonate filler of 2.8 μm size.

In addition to speeding up the drying during the hot press compression molding and the improvement of the dimensional stability of the molded cellulose filament binderless products, FIG. 5 shows higher tensile strength of the panels containing 20% by dry weight of calcium carbonate having the mean particle size of 2.8 μm with respect to the unfilled panel. This tensile strength increase could achieve up to −18% (in case of the 90 min hot press compression molded panel) with respect to the tensile strength of 100% cellulose filament panel made by compression molding. Unlike, the calcium carbonate grade with mean particle size of 25 μm reduced the tensile strength by ˜27% drop in tensile strength in comparison with the 100% cellulose filament panel made by compression molding.

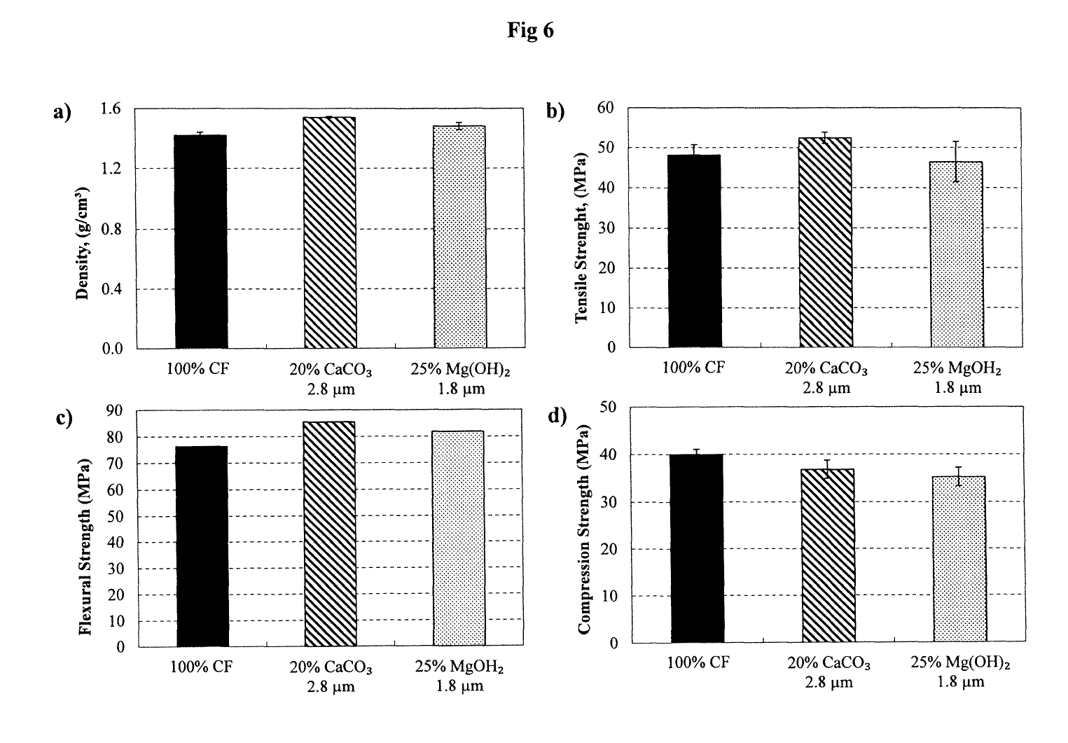

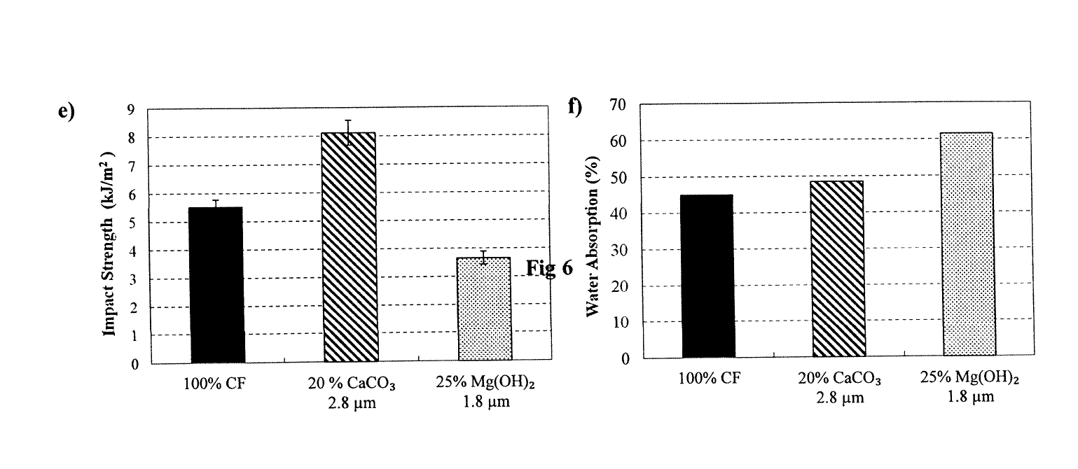

FIG. 6 summarizes the effect of a 20% by weight addition of calcium carbonate, with mean particle size of 2.8 μm, and the effect of a 25% by weight addition of magnesium hydroxide, with mean particle size of 1.8 μm, on different properties of binderless cellulose filament panels made by compression molding. With respect to 100% cellulose filament panel, the density increase of 4-8% of the inorganic filler containing panels is not significant. Despite addition of 20-25% inorganic filler in the panels, tensile and flexural strength increased from 4-11%. In thermoplastics, this level of charge corresponding to a volume fraction of 12-15% would have reduced the tensile yield stress by 24-30% as described by J. Suwanprateeb, Elsevier—Composites: Part A 31, 353-359, 2000. Other significant changes include an increase of 32% on impact strength for the calcium carbonate containing panel but a decrease of 34% for the magnesium hydroxide containing panels. The compression strength of both filler containing panels decreased by 8-13%. One of the drawbacks of filler addition is that a 35% increase in the water absorption was noted for the 25% magnesium hydroxide containing panel. With all of these results, clearly, in addition to the novelty of accelerating the dewatering in hot press compression molding, there is opportunity to control panel properties through filler selection.

In addition to the calcium carbonate and magnesium hydroxide, other inorganic fillers, such as aluminum hydroxide, aluminum oxide, and zinc borate (technical light, Sigma-Aldrich 14470), were also successfully tested to reduce the drying time during compression molding process. In addition to changes in mean particle size of the filler, changes in filler particle shape could also affect the drying rate and final properties of the cellulose filament products made by compression molding. Combinations of different filler types, shape and mean particle size could change drying rate and product characteristics but also may have a synergistic effect on drying and physico-mechanical properties of the compression molded products. Note that other types of inorganic fillers could also be used to improve drying rate but also to add functionality such as color, brightness, magnetism, conductivity, fire resistance, hardness, impact resistance, bullet proofing, acoustic insulation, dimensional stability and surface properties such as smoothness. In other embodiments, addition of lower density fillers such as inorganic hollow microspheres might be selected for lowering the final binderless product density. Expandable polymeric beads can also be added for further lightweight binderless products.

As the inorganic fillers are less hydrophilic than the cellulose filaments, they tend to dry faster than the surrounding cellulose filaments when exposed to hot pressing during compression molding. One of the potential mechanisms for this accelerated drying may involve this dryness differential that will drive the water and the vapor from the cellulose filament toward the closest inorganic particle, and so on. Thus, the inorganic filler particles act by creating a path for water and vapor evacuation during the hot pressing and drying.

Preform, Molding and Drying

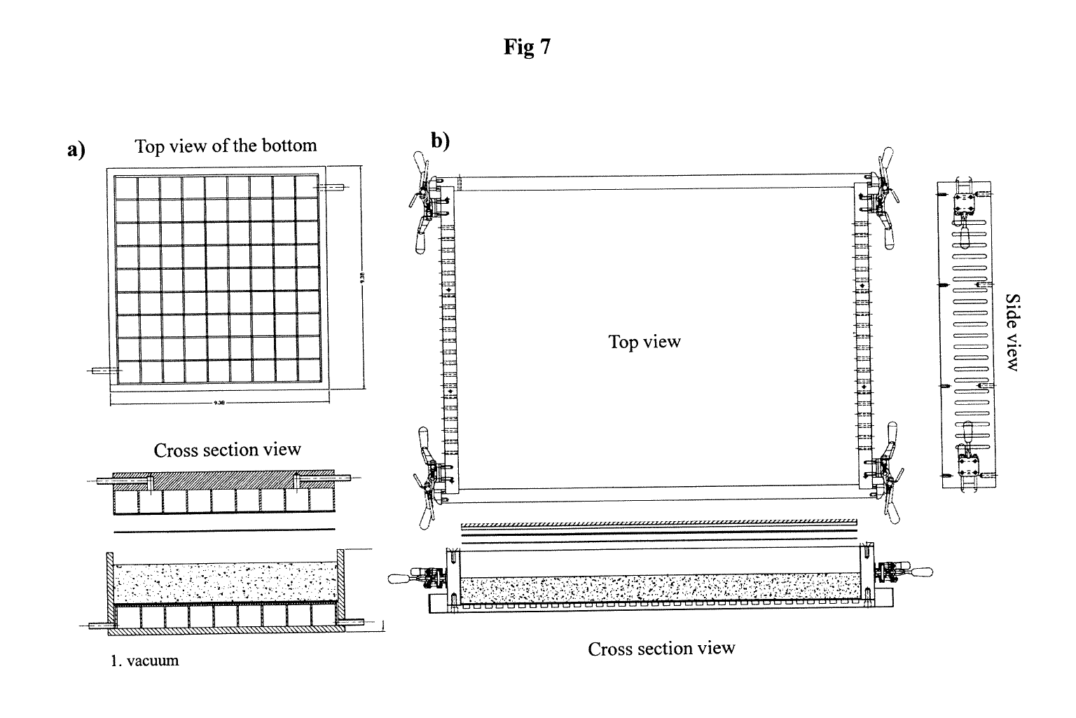

The cellulose filaments based suspensions with inorganic fillers are dewatered in specially designed jig to generate the desired preform. FIG. 7a-b illustrates bottom/top, side and cross-sectional views of a vacuum assisted flat dewatering jig (a) and a four to six face flat dewatering jig (b). When the suspension is transferred uniformly from the compounder into the jig, water can leave the compound from the six faces of this latter jig. Releasing porous fabrics, such as a polyester peel ply, can be placed at the interface between the jig and the cellulose filaments based aqueous compound mainly to facilitate the removal of the preform from the jig. The shape and the dimensions of the preforming jig are related to the final product design.

As per the embodiments described herein, the pre-forming may be conducted at room temperature or at temperatures below 100° C. The applied pressure was set at 250 psi.

As illustrated in FIG. 3, after the preforming step, the preform can be demolded, if it is self-supporting, and then transferred into the hot press mold for final compression and drying. In some embodiments the preform can be transferred within its preforming jig into the hot press mold for final compression and drying. In some embodiments the preform can be supported within its jig to accomplish the remaining dewatering by air dry process.

In a hot press molding process, the press platen temperatures and the pressure subjected on the preform are controlled and cycled to optimize the drying time and usually to maximize the molded part properties. Table 1 shows different compression molding and drying cycles. For example, in the cycle 3, the temperature is kept constant at 110° C. for the first 10 minutes and then increased and maintained at a maximum of 150° C. for 15 minutes. After the maintenance period, the temperature is gradually decreased to the initial starting temperature of 110° C. Simultaneously, the pressure rises by three step increments to reach 250 psi after 10 minutes, 500 psi after 15 minutes and a maximum of 1000 psi after 17 minutes. The pressure is then kept constant for 23 minutes before it is released to atmospheric pressure for a complete cycle time of 45 minutes.

TABLE 1
Different compression molding and drying cycles

| | | Phase 1 | Phase 2 | Phase 3 | Phase 4 | Phase 5 | Phase 6 | Phase 7 |
|---|---|---|---|---|---|---|---|---|
| Cycle 1 | Temperature (° C.) | 110 | 110 to 150 | 150 | 150 to 110 | | | |
| | Pressure | 247 | | | 247 to 0 | | | |
| | (psi) | | | | | | | |
| | Time | 5 | 10 | 5 | 10 | | | |
| | (min) | | | | | | | |
| Cycle 2 | Temperature (° C.) | 110 | 110 to 150 | | 150 | 150 to 110 | | |
| | Pressure | 150 to 247 | | 247 | | 247 to 0 | | |
| | (psi) | | | | | | | |
| | Time | 5 | 5 | 5 | 5 | 5 | 5 | 5 |
| | (min) | | | | | | | |
| Cycle 3 | Temperature (° C.) | 110 | 110 to 150 | | 150 | 150 to 110 | | |
| | Pressure | 150 to 250 | 250 to 500 | 500 to 1000 | 1000 | | | 1000 to 0 |
| | (psi) | | | | | | | |
| | Time | 10 | 5 | 2 | 3 | 15 | 5 | 5 |
| | (min) | | | | | | | |

| | | | | | |
|---|---|---|---|---|---|
| Cycle 4 | Temperature (° C.) | 115 | 115 to 140 | 140 | 140 to 115 |

| Pressure | 150 to 250 | | 250 to 1000 | 1000 | 1000 to 0 | |
|---|---|---|---|---|---|---|
| (psi) | | | | | | |
| Time | 5 | 5 | 3 | 6 | 1 | 5 |
| (min) | | | | | | |

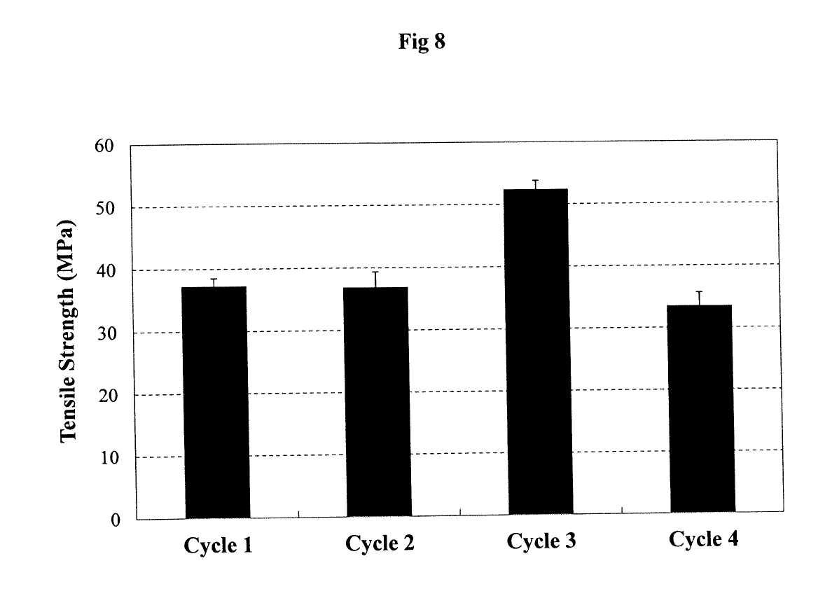

The drying and molding cycle will have an impact on hydrogen bonding density as well as the whole consolidation quality, and thus the mechanical properties. This is illustrated in FIG. 8, where cycle 3 is found significantly superior to other cycles (1, 2 and 4). The mechanism as to why cycle 3 is superior to the other cycles is believed to relate to some factors such as a more gradual increase in temperature and pressure and the final higher pressure may be important, as it improves the tensile strength by more than 15 MPa. Other molding cycles for example at higher pressure may improve the performance of the cellulose filament products.

Other means of drying could eventually be considered such as oven drying, microwave, radio frequency, all of which could be assisted with a vacuum system. Freeze drying might also be considered for lightweight cellulose filaments based products.

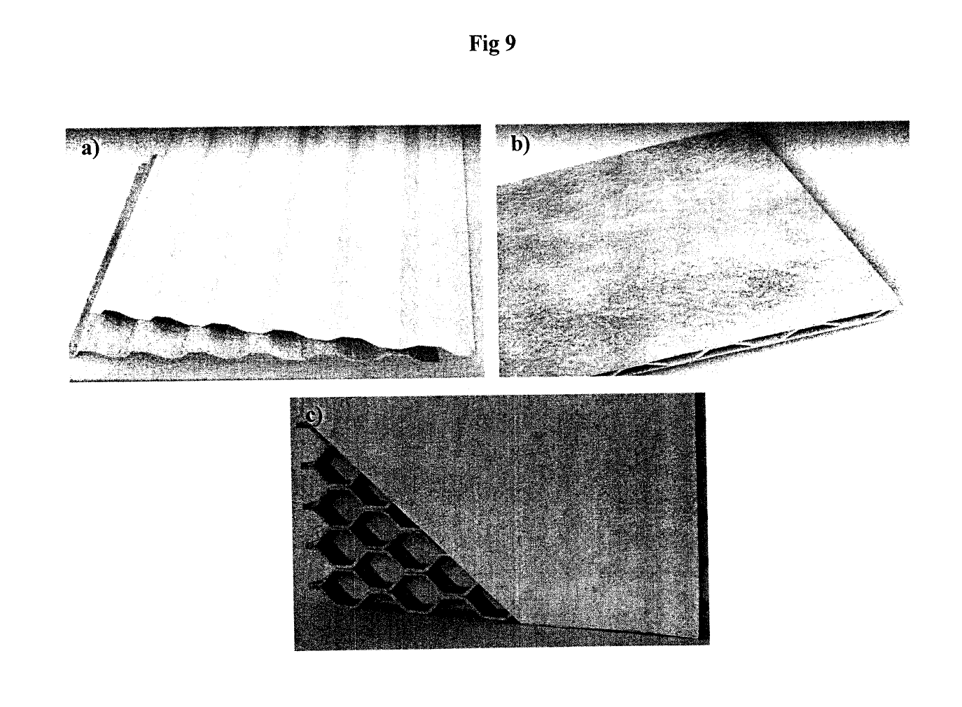

FIG. 9 shows photographs of some embodiments of hot pressed compression molded products of different shapes made from cellulose filament based suspension. It should be highlighted here that the preforming flat jig of FIG. 7 was used to generate the preforms. These preforms were then shaped in the final hot press mold when subjected to the applied pressure.

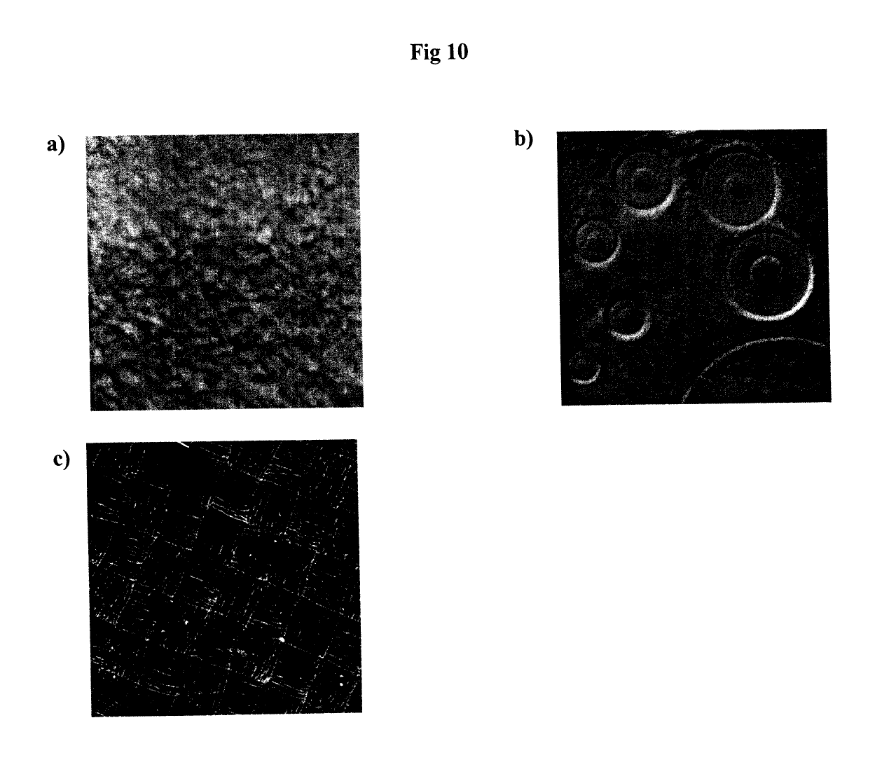

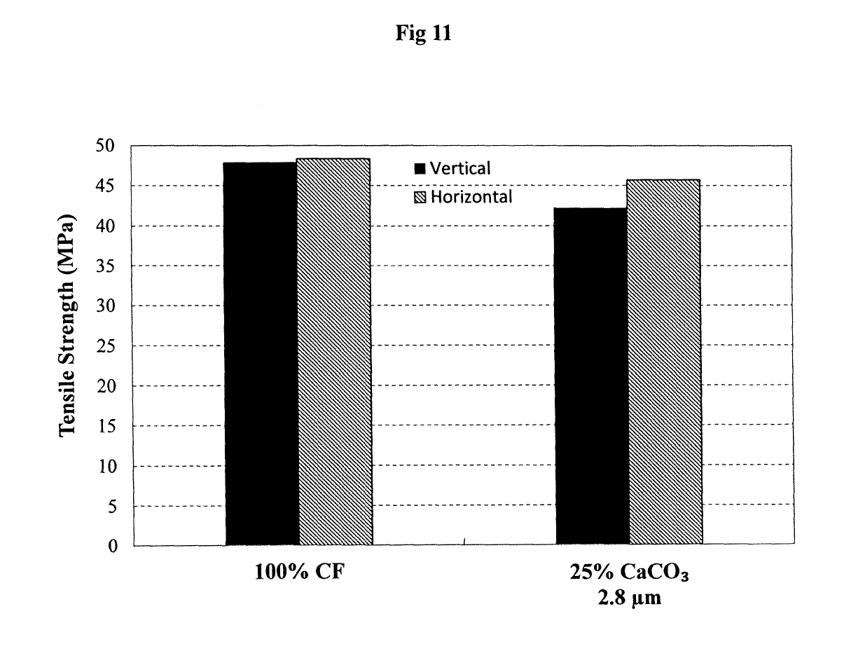

A variety of different surface finishes can be produced either from the mold used, from an insert embedded in the mold or by mechanical action or cutting of the cellulose filament molded product. FIGS. 10a-d show four examples of finishes of cellulose based products: a) dried as described in mold of FIG. 7, b) embossed, and c) imprinted with a wire mesh for cellulose based panels produced via compression molding and d) obtained by the mechanical action of a milling machine on an air dried product.

Contrary to wood that have oriented fibers or engineered wood products that have oriented particles, the cellulose filaments are randomly oriented in compression molded products. FIG. 11 shows the in-plane isotropic nature of one mechanical property, tensile strength, of both pure cellulose filament compression molded products with and without fillers. Both samples cut in horizontally (x axis) or vertically (y axis) show the nearly same tensile strength.

In accordance with this present disclosure, Table 2 shows comprehensive comparison of CF-based panel properties with respect to commercial wood fibre based panel, both binderless and hot press molded. As clearly shown, CF-based molded products can address different market needs, that actual sustainable commercial binderless products cannot, where higher overall performance is required.

TABLE 2
Representative properties of the hot press molded binderless
CF-based panels preformed after 5% consistency and containing
20 wt. % of CaCO₃ (mean particle size 2.8 μm) with
regards to commercial binderless wood fibre based panels

| | CF-Based | Commercial Wood Fibre- |
|---|---|---|
| Properties | (1.54 g/cm³) | Based (0.92 g/cm³) |
| Tensile Strength (MPa) | 72.5 ± 3.3 | 41 ± 5.8 |
| Tensile Modulus (GPa) | 4.9 ± 0.6 | 3.3 ± 0.3 |
| Tensile Strain (%) | 2.3 ± 0.2 | 2.7 ± 0.7 |
| Flexural Strength (MPa) | 91.2 ± 5.6 | 48.7 ± 6.1 |
| Flexural Modulus (GPa) | 7.6 ± 0.4 | 3.7 ± 0.5 |
| Flexural Strain (%) | 1.9 ± 0.2 | 3.3 ± 1.2 |
| Water Absorption (%), 2/24 hrs. | 26/49 | 116/127 |
| Thickness Swelling (%), | 18/44 | 66/71 |
| 2/24 hrs. | | |

The method described herein produces binderless products from cellulose filament compositions from aqueous suspension more quickly and in an industrially viable manner by forming a hot press compression molding.

Addition of inorganic fillers such as calcium carbonate of smaller mean particle size in the cellulose filament compound to control drying rate during the hot press compression molding process has surprisingly improved dimensional stability and strength properties of the molded product. Cellulose filament preforms with or without inorganic fillers or organic additives for subsequent hot press compression molding or ambient air dried process are also disclosed.

Although hot press compression molding, mainly through the addition of inorganic fillers, seems like an industrially viable process, the ambient air dried products have superior features that may justify their longer production times. With their unique water and fire resistance, and marble-like features, these air dried products from cellulose filaments could be used in different markets. Furthermore, a combination of compression molding with a final air dried step may provide characteristics that near the air dried products.

### REFERENCE LIST

(1) Hua X, Laleg M, Owston T, inventors, FPlnnovations, assignee. Cellulose nanofilaments and method to produce same. United States patent US20110277947A1. 211 November 2011.
(2) Hua X, Laleg M, Miles K, Amiri R, Ettaleb L, Dorris G, inventors. FPlnnovations, assignee. High aspect ratio cellulose nanofilaments and method for their production. United States patent US20130017394A1. 213 January 2013.
(3) Döpfner H, Ernegg M, Bramsteidl R, inventors. Zellform Gesellschaft, assignee. Process for producing workpieces and molded pieces out of cellulose and/or cellulose-containing fiber material. United States Patent U.S. Pat. No. 6,379,594B1. 22 Apr. 2002.
(4) Dean T, Hurding R, inventors. PHILLIPS/HURDING GBR, INTERFACE INTERNATIONAL BV assignee. Products utilising fibre and/or fibre pulp. International patent WO2011/138604 A1. 211 November 2011
(5) Döpfner H, Ernegg M, Bramsteidl R, inventors. Zellform Gesellschaft, assignee. Process for producing workpieces and molded pieces out of cellulose and/or cellulose-containing fiber material. Application CA2237942 1997 October 1997 1998 March 1998.
(6) Dean T, Hurding R, inventors. Products utilizing fiber and/or fiber pulp. United States Patent US20130101763 Al 213 April 2013
(7) Lee C, Hunt J, inventors. Binderless panel made from wood particles and cellulosic fibers. United States Patent US20130199743A1. 213 August 2013
(8) Laleg M, Hua X, inventors. FPlnnovations, assignee. Cellulose-reinforced high mineral content products and methods of making the same. Patent WO/2012/040830 A1. 212 April 2012.
(9) Dorris G, Ben Y, An Q, Dorris A, Wang X inventors, FPlnnovations, assignee. Compositions, panels and sheets comprising mineral fillers and methods to produce the same. United States Patent US20160102018A1 216 April 2016

1. A method of producing an in-plane isotropic product comprising
providing a cellulosic filament substantially free of a binder;
providing an inorganic filler comprising an average particle size of less than or equal to 5 μm;
mixing the cellulosic filament and the filler to produce a suspension;
transferring the suspension to a preforming jig to produce a mat in the jig; and
compression molding the mat to produce the in-plane isotropic product.

2. The method according to claim 1, wherein the mat is further pressed to produce a preform and the preform is compression molded to produce the in-plane isotropic product.

3. The method according to claim 1 or 2, wherein the suspension is 5 to 10 wt % solids.

4. The method according to claim 2, wherein the preform is a consistency of 30 to 55 wt % solids.

5. The method according to any one of claims 1 to 3, wherein the inorganic filler is selected from the group consisting of CaCO₃, Mg(OH)₂, Al(OH)₃, Al₂O₃, B₂O₆Zn₃ or combinations thereof.

6. The method according to any one of claims 1 to 5, wherein the average particle size of the filler is less than 3 μm.

7. The method according to any one of claims 1 to 5, wherein the average particle size of the filler is between 1 and 3 μm.

8. The method according to any one of claims 1 to 7, wherein the suspension dewatering is at ambient temperature and 250 psi.

9. The method according to claims 1 and 2, wherein the in-plane isotropic product is compression molded at a temperature above the boiling point of the water and less than a thermal degradation temperature of the cellulosic filament.

10. The method according to claim 9, wherein the temperature of compression molding is 150° C.

11. The method according to claim 1, wherein the in-plane isotropic product is hot press compression molded within a reduced time significantly shorter than the time of an in-plane isotropic product containing no inorganic filler.

12. The method according to claim 5, wherein the filler is 10 to 30% of the weight of the cellulose filament.

13. The method according to claim 5, wherein the filler is 20% of the weight of the cellulose filament.

14. An in-plane isotropic product comprising
a cellulosic filament substantially free of a binder;
an inorganic filler comprising an average particle size of less than or equal to 5 μm.

15. The product according to claim 14, wherein the inorganic filler is for instance selected from the group consisting of CaCO₃, Mg(OH)₂, Al(OH)₃, Al₂O₃, B₂O₆Zn₃ or combinations thereof.

16. The product according to claim 14, wherein the average particle size of the filler is less than 3 μm.

17. The product according to claim 14, wherein the average particle size of the filler is between 1 and 3 μm.

18. The product according to any one of claims 14 to 17, wherein the product comprising 20% by weight of filler has a density in the range of 1.5 g/cm³.

19. The product according to any one of claims 14 to 17, wherein the product comprising 20% by weight of filler has a tensile strength greater than 50 MPa.

20. The product according to any one of claims 14 to 19, wherein the product comprising 20% by weight of filler has a flexural strength greater than 80 MPa and superior to that of the product comprising no filler.

21. The product according to any one of claims 14 to 19, wherein the product comprising 20% by weight of filler has an impact strength greater than 8 kJ/m² and superior to that of the product comprising no filler.
